(19) United States
(12) Patent Application Publication
(10) Pub. No.: US 2003/0093359 A1
(43) Pub. Date: May 15, 2003

(54) Odd lot processing in centralized automated market system

(76) Inventors: Peter Martyn, Ridgewood, NJ (US); Karen Peterson, Fairfield, CT (US)

Correspondence Address: FISH & RICHARDSON PC, 225 FRANKLIN ST, BOSTON, MA, 02110, US

(21) Appl. No.: 10/001,240

(22) Filed: Nov. 14, 2001

(51) Int. Cl. G06F 17/60

(52) U.S. Cl. 705/37

(57) ABSTRACT

An electronic market for trading of securities includes a plurality of client stations for entering quotes for securities and a server process. The market has a facility, which receives quotes from the clients, aggregates the quotes and causes a total of all aggregated quotes to be displayed for a plurality of price levels on the client systems. The market uses a graphical user that depicts aggregated quotes in an aggregate window, and a plurality of price levels of a product traded in the market. The market also includes processes to handle odd-lot processing and provides a central quote/order collector that interfaces to disparate order delivery systems to minimize dual liability of market makers.

### BACKGROUND

This invention relates to trading systems particularly financial trading systems.

Electronic equity markets, such as The Nasdaq Stock Market® collect, aggregate, display pre-trade information to market participants. Electronic equity markets also provide trading platforms through which market participants may access liquidity indicated in the marketplace. In some types of markets customer orders are entered by broker/dealers or equivalents and traded against other orders or quotes that are displayed by market makers or electronic commerce networks (ECN's). Sometimes orders are for what is commonly referred to as an odd lot, e.g., an order that is not a multiple of 100 shares.

One type of trading platform is the Small Order Execution System (SOES^{SM}). The Small Order Execution System can be used to access, e.g., market makers quotes, via automatic execution if the order is for a public customer and meets a maximum order size requirement. Conventionally, in systems such as the Small Order Execution System (SOES^{SM}) odd lots are processed against only those market makers who are at the inside bid or offer, in round-robin fashion. An odd-lot execution does not decrement or decrease a market maker's quote by the amount of the execution.

### SUMMARY

According to an aspect of the present invention, a method for trading odd-lots of a security in an electronic market for trading securities, includes executing an odd-lot order with an eligible market participant and updating an odd-lot position of the eligible market participant to reflect the executed odd-lot order. The method further includes determining when the odd-lot position for the eligible market participant corresponds to a round lot size and decrementing the odd-lot position by the round lot size.

According to an additional aspect of the present invention, an electronic market for trading securities, includes an order execution/routing manager that executes non-directed orders against quoting market participant's quotes/orders based on a priority and a process to determine whether an order is a mixed order or an odd lot order. The market also includes an odd-lot execution process that executes the odd-lot portion of the mixed order or the odd-lot order. The odd-lot execution process includes a process to execute an odd-lot order with an eligible market participant, a process to update an odd-lot position of the eligible market participant to reflect the executed odd-lot order and determine when the odd-lot position for the eligible market participant corresponds to a round lot size, and a process to decrement the odd-lot position by the round lot size.

According to an additional aspect of the present invention, a computer program product residing on a computer readable medium for trading securities in an electronic market, comprises instructions for causing a computer to determine whether a received order is a mixed order or an odd lot order and execute an odd-lot order with an eligible market participant. The product also includes instructions to update an odd-lot position of the eligible market participant to reflect the executed odd-lot order and determine when the odd-lot position for the eligible market participant corresponds to a round lot size and decrement the odd-lot position by the round lot size.

One or more of the following advantages may be provided by one or more aspects of the present invention.

The invention maintains counters that manage exposures of a market maker to odd lot trades. The invention facilitates odd lot and mixed lot trading while minimizing rejection of odd lots. At the same time the invention minimizes impact to market maker systems and other odd lot eligible participants. The invention also minimizes trader and market maker gaming and maximizes order flow to the system.

### BRIEF DESCRIPTION OF THE DRAWINGS

FIG. 1 is a block diagram of a market system.

FIG. 1A is a diagram showing a format for quotes.

FIG. 2A is a block diagram showing arrangement of an quote/order collector facility.

FIG. 2B is a logic view of functions in the quote/order collector facility.

FIG. 3A is a flow chart showing a quote/order manager.

FIG. 3B is a flow chart showing a montage manager.

FIGS. 4A-4B are flow charts of an execution/routing manager.

FIGS. 5A-5B are flow charts showing an odd lot execution manager.

FIGS. 6A-6B are flow charts depicting additional odd lot execution processes.

### DESCRIPTION

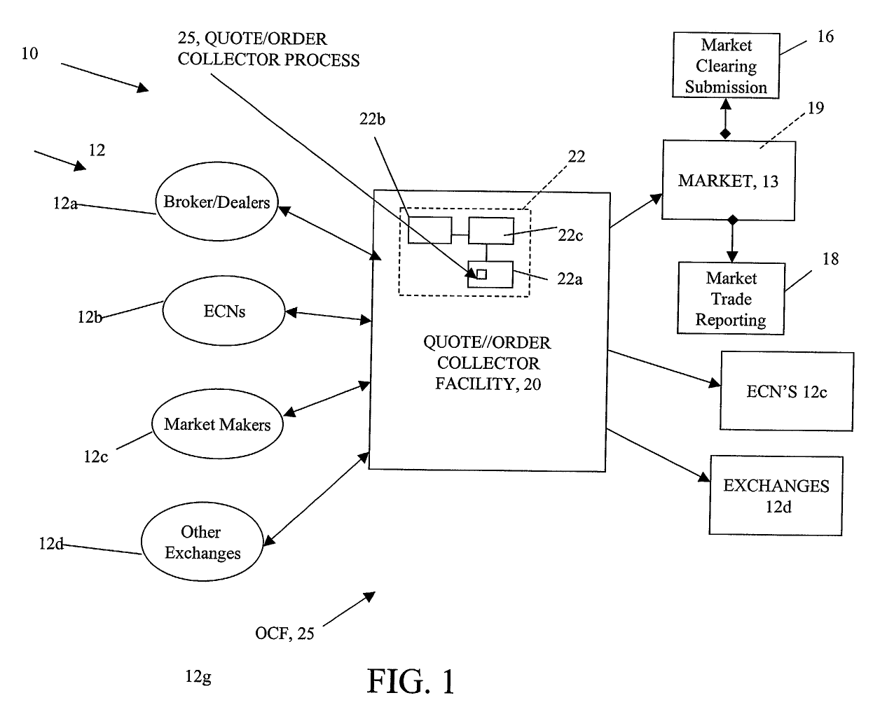

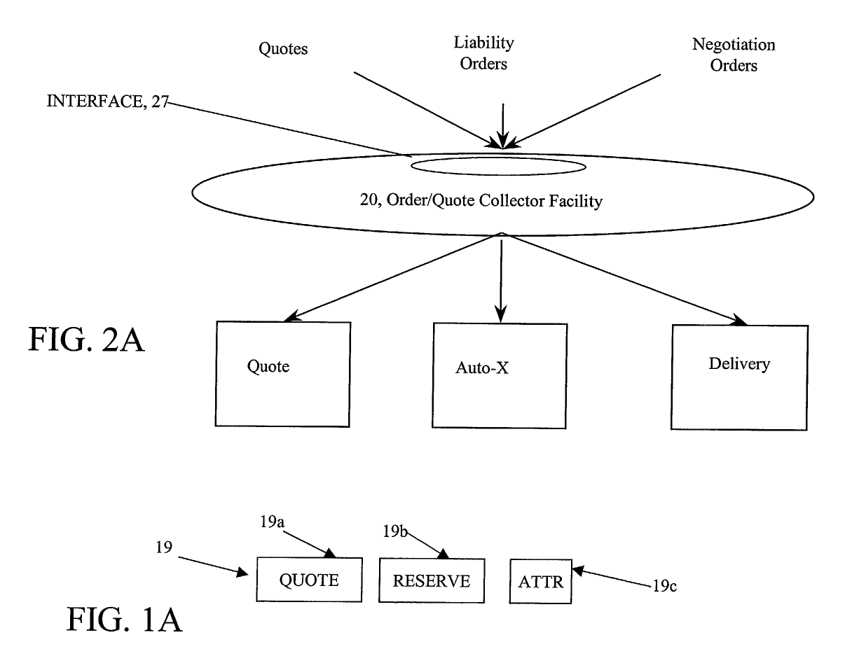

Referring to FIG. 1, an electronic market 10 is shown. The electronic market 10 includes client systems 12 that access a central quote/order collector facility 20. The client systems 12 can be broker/dealer systems 12a, electronic communication networks (ECN's) 12b, market-marker systems 12c, and other exchanges 12d. The connections can use existing Nasdaq protocols such as SelectNet®, Small Order Execution System^{SM} (SOES^{SM}), and or equivalent. The client systems 12 include a processor, memory and a storage device, e.g., a client workstation or personal computer (all not shown) that can include a client process to enter quotes/orders into the electronic market system. The quote/order collector facility 20 causes the order execution or order delivery systems (e.g., SOES^{SM} and SelectNet®) to deliver executions or orders to a market that is coupled to a clearing system 16 and a reporting system 18. It also causes delivery of executions or routing of orders to the ECN's 12c, depending on the status of the ECN, and routing of orders or executions to other markets and exchanges 12d.

The quote/order collector facility 20 is comprised of one or preferably a plurality of server computers generally denoted as 22 including a processor 22a, main memory 22b and storage 22c. The storage system 22c includes quote/order collector process 25 that is executed in memory 22b. In general, server 22 is a complex computer server, the details of which are not important to an understanding of the present invention.

The quote/order collector facility 25 collects pre-trade information in the form of quotes or orders. The distinction between a quote and an order depends on several factors. For example, each a market maker can send a proprietary quote, i.e., a quote that represents its own trading interest or an agency quote that represents trading interest of a sponsored entity. If one proprietary quote is sent it could be considered one order. If one agency quote is sent it also could be considered one order. If an agency quote reflects an aggregation of more than one agency order, however, the aggregate agency order could be considered a quote. Entering quotes are limited to registered market makers 12b and ECNs 12c and possible UTP Exchanges 12d. For any given stock, a registered market maker or ECN may directly enter a non-marketable order, i.e., quote into the system 20 on behalf of its own account or for the account of a customer, or it may sponsor the direct entry of an order by its customer. All sponsored quotes are sent to the quote/order collector facility 20 under the name of the sponsoring market maker or ECN. Every registered market maker or ECN will be permitted to submit an unlimited number of non-marketable quotes to the system 20.

As shown in FIG. 1A, each quote 19 submitted to the system can include a display quote size 19a, a reserve size 19b and an indication 19c (ATTR) of whether the quote size is attributable or non-attributable. Quote size 19a when attributable based on indicator 19c, is directly attributable to the market maker or ECN, and is placed next to its unique market participant ID, and is displayed in a “current quote” montage. Quote size 19b when non-attributable is sized that the market maker or ECN wishes to display to the marketplace through an aggregate montage of the order display window. This quote size 19a is not attributable to the market maker or ECN until it is executed. Reserve size 19b is liquidity that is not displayed to the marketplace but that is immediately accessible through the quote/order collector facility 20. In order to use reserve size 19b, a market maker can be required to have a minimum amount displayed in the aggregate quote size 19a without or with attributable indicator 19c and negotiation quote with attributable indicator 19c asserted.

A broker/dealer can receive an order from a customer. The broker/dealer can send that order to the order collector facility 20 to be executed with quotes that are posted by electronic communication networks, market makers or other markets. In this embodiment, orders of broker/dealers are not posted as quotes.

Order Collector Facility

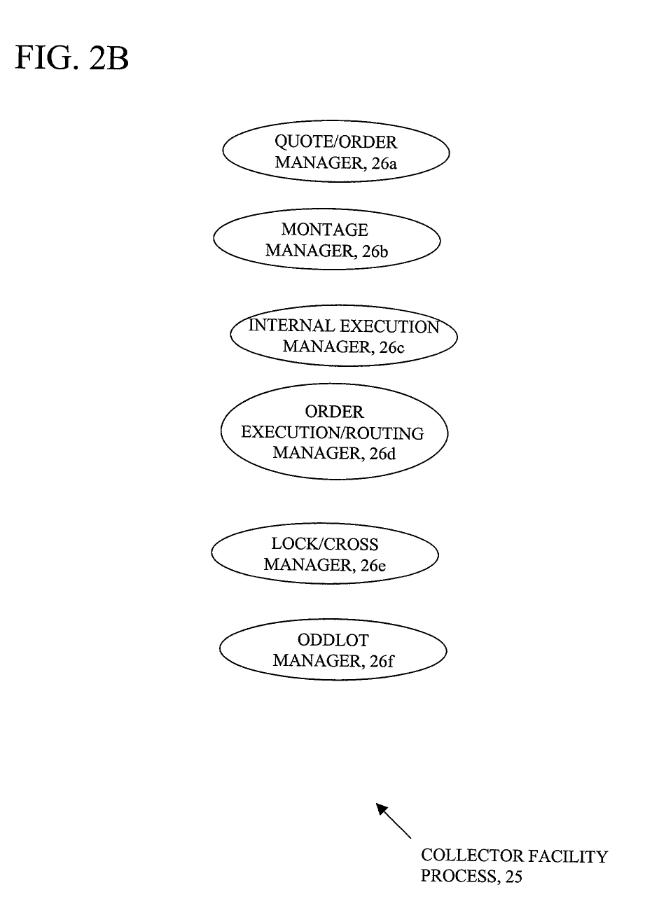

Referring to FIG. 2A, the quote/order collector facility 20 receives quotes, liability orders, (non-liability orders) and directed orders from market participants. The quote/order collector facility 20 allows a quote/order to be displayed in the market, and also allows for marketable orders to be executed or routed to market participants.

The order quote collector facility 20 also includes an interface 21 that couples the order collector facility 20 to a plurality of order delivery systems. For example, the interface 21 can couple the order quote collector facility 20 to an order execution system, e.g., the Small Order Execution System^{SM} (SOES^{SM}) and to a negotiation system, e.g., SelectNet®. The interface 21 would provide access to information contained in order flow delivered via the delivery systems to a quote/order collection process 25 described in conjunction with FIG. 2B. In general, the electrical and logical functions which comprise the interface 21 can be similar to the ones currently existing in the SOES^{SM}/SelectNet® systems or equivalents. The interface 21 or the process 25 would extract information from the quotes and make that information available to the quote order collector process 25. The quote/order collector process 25 extracts information and process orders in a unified manner to allow the order collector system 20 to be a unifying point of collection of all orders which are sent to the market 10.

The interface 21 can also be used to route executions of liability orders back to market participants whose quotes/orders were executed against and can deliver orders for negotiation against market participants whose quotes are selected for further negotiation via the SelectNet® system or equivalent.

Referring to FIG. 2B, the quote/order collector process (“OCP”) 25 is shown. The quote/order collector process 25 provides transmission of multiple orders or quotes at multiple price levels by Quoting Market Participants to a quotation manager 26a. The quote/order manager 26a provides a unified point of entry of quotes and orders from disparate delivery systems into the quote/order collector facility 20 to access quotes/orders displayed (as either attributable or non-attributable) in both the aggregate montage and current quote montage. The quote/order manager 26a manages multiple quotes/orders and quotes/orders at multiple price levels and uses a montage manager 26b to display (either in the Aggregate montage or in the current quote montage) the orders/quotes consistent with an order's/quote's parameters. The order collector process 25 also includes an internal execution process manager 26c to match off executions for quoting market participants at the best bid/offer. The order collector system 20 also includes an order routing/execution manager 26d provides a single point delivery of executions or routing of orders, which substantially eliminates potential for dual liability. That is, order collector process 25 will maintain the order routing and executions functionality available in the SOES^{SM} and SelectNet® systems. The order collector process 25 also includes a quote update manager 26e, a lock/cross quote manager 26f, and an odd lot execution manager 26g.

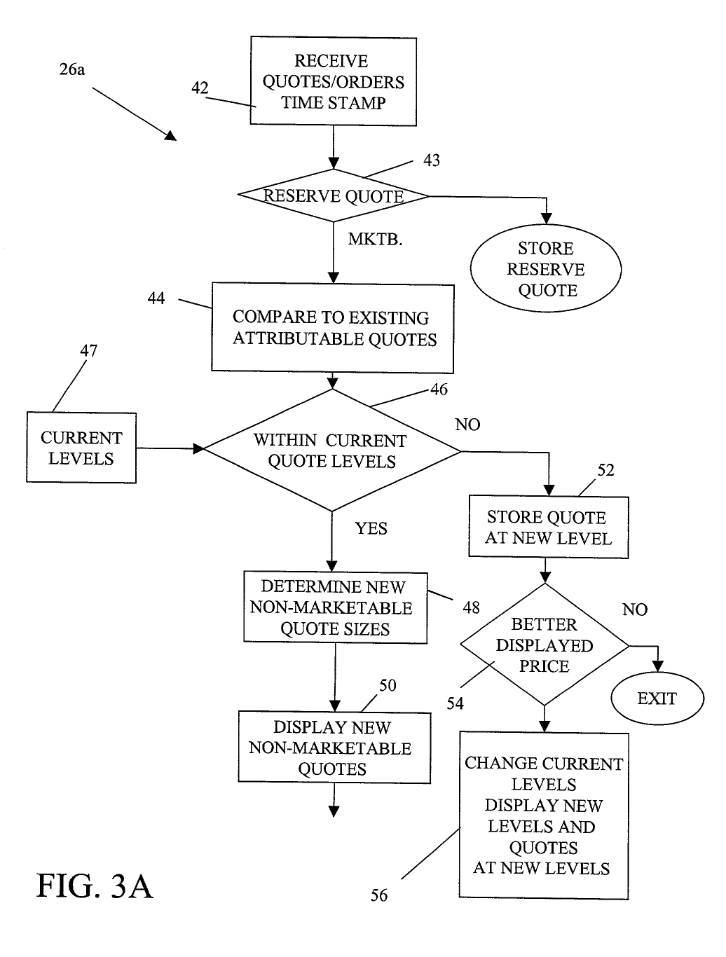

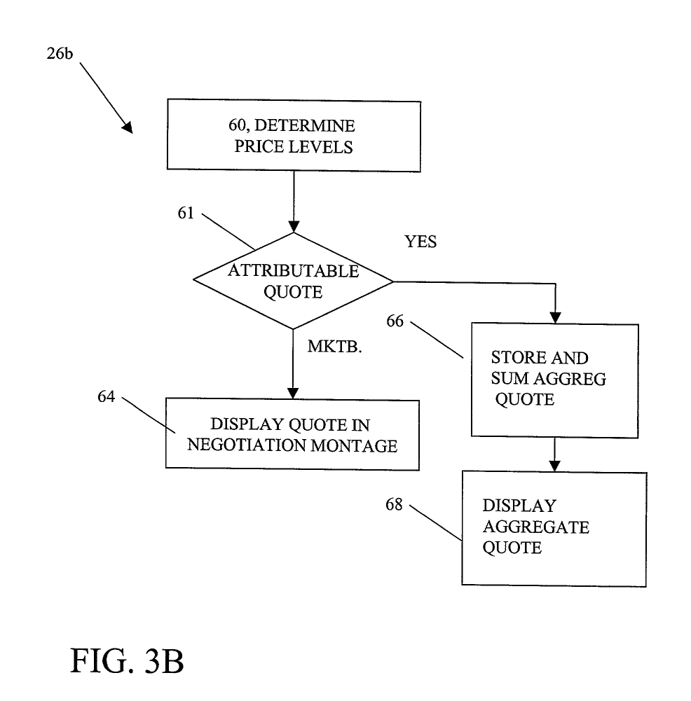

Referring to FIG. 3A, the order collector process 25 receives orders/quotes and time stamps 42 each order/quote upon receipt. This time stamp determines the order's/quote's ranking for interaction with incoming marketable orders. Quotes/orders are designated as either attributable or non-attributable, and could also have a reserve size discussed above. The order collector process 25 aggregates all of a Quoting Market Participant's attributable and non-attributable orders at a particular price level, and disseminates order/quotation information into the aggregate montage and/or the current quote montage, as will be discussed below.

The order entry process 25 determines 43 whether the received quote/order corresponds to a reserve quote. If the quote does not correspond to a reserve quote then the quote is a displayable quote that is attributable or non-attributable. The order entry process 25 compares 44 the received quotes/orders to existing quotes/orders to determine 46 whether the price of quotes/orders fall in existing quote/order price levels. Any number of quote/order price levels can be accommodated although, in this example, only three price levels will be displayable in the non-attributable i.e., aggregate montage. If the quote price is in a displayable price level it is a displayable quote eligible for automated execution. The order collector system 20 can be provided with more price level depth than the three levels, e.g., a depth of 20-25 levels although only a limited number, e.g., three would be displayed at any one time.

If the quote is within one of the pre-defined quote levels, the process 25 determines 48 new non-marketable quote/orders sizes by adding the quote/order size corresponding to the received quote/order to quote sizes at that price level already in the system 20. The process 25 will cause the new non-marketable quote sizes to be displayed 50. If the quote is not within one of the pre-defined quote levels, the process 25 stores 52 the quote at a new price level determines 54 if it is at a better price. If the quote is at a better price, the process 25 changes 56 current levels to cause a new price level for non-marketable quote sizes to be displayed 50.

Referring to FIG. 3B, the montage manager 26b of the quote/order collector process 25 determines 60 which price levels to display 60 and determines 61 if an order is a non-attributable order. If the order is non-attributable, the quote/order collector process 25 will store and sum 66 the quote with like quotes to produce an aggregated quote and display 68 the aggregate size of such orders in the aggregate montage when the orders fall within one of the three top price levels. For attributable orders, the aggregate size of such orders is displayed in the current quote montage once the order(s) at a particular price level becomes the particular quoting market participant's best attributable bid or offer in the current quote montage. This interest will also be aggregated and included in the aggregate montage if it is within the displayed price levels. Market makers and ECNs can have one unique market participant identification “MPID” and possibly an agency MPID against which they can display attributable quotes. If a market maker has an agency quote, attributable orders will be displayed once the order or orders at a particular price level become the market participant's best agency quote.

For example, MMA sends system 20 five 1,000 shares attributable buy orders at $20 and two 1,000 share non-attributable buy orders at $20, for a total interest of 7,000 shares to buy at $20. At some point, the $20 price level becomes the best bid. In this example, if MMA is alone at the inside bid, system 20 will aggregate all of the orders in the system and display as follows: 7,000 shares in the Aggregate montage; 5,000 shares (the attributable portion) in the current quote montage next to MMA's MPID; and 2,000 (the non-attributable portion) in a “SIZE” MPID.

Quote/order collector system 20 provides several advantages to the market. One advantage is that it ensures compliance with the regulatory rules such as the SEC Order Handling Rules, and in particular the Limit Order Display Rule and SEC Firm Quote Rule. With system 20 it is less likely that a Quoting Market Participant, because of system delays and or/fast moving markets, will miss a market because the Quoting Market Participant is unable to quickly transmit to System 20 a revised quote (which may represent a limit order).

ECNs do not currently participate in the SOES^{SM} execution system because of the potential for dual liability and assuming proprietary positions. For example, if an ECN matches orders between two subscribers and contemporaneously receives an execution from SOES^{SM} against its quote, the ECN will be required to honor both the internal execution and the SOES^{SM} execution, thus taking on a proprietary position. This issue of liability does not arise in SelectNet® because that system delivers orders which can be declined if the ECN, after scanning its book, determines that the quote was taken out by an internal execution. An ECN cannot decline a SOES^{SM} execution because the system delivers an execution, as opposed to an order.

An ECN, like a market maker, can have the ability to give orders to the system 20. If an internal subscriber wants to access an order in an ECN that is also being displayed in system 20, the ECN can request a cancel before accomplishing the internal match. If the request to cancel is declined because the order was already executed against in system 20, the ECN can decline the internal customer and avoid the potential for dual liability.

The OCF 20 will eliminate virtually all potential for double liability using the disparate execution and delivery systems that exist today because OCF 20 will serve as the single point of order entry and the single point of delivery of all Liability Orders (as well as Non-Liability Orders).

To access quotes in system 20, therefore, order entry firms, market makers, ECNs, or UTP Exchanges, will enter either a directed or non-directed order into the OCF 25. The order may be of any size. The order indicates whether it is a buy, sell, sell short, or sell short exempt. The order is either a priced order or a market order. The system 20 has a separate odd lot process described below.

Nondirected Orders

A market participant can immediately access the best prices in system 20 as displayed in the aggregate montage, by entering a non-directed order into the OCF 25. A non-directed order is an order that is not sent/routed to a particular Quoting Market Participant. A non-directed order is designated as a market order or a marketable limit order and is considered a “Liability Order” and treated as such by the receiving market participant. Additionally, the order entry participant can obtain the status of the order and request a cancel of such order. Further, in some embodiments, the market 10 allows market participants that enter Non-Directed Orders three options as to how the order interacts with the quotes/orders in the system 20. These choices are that the orders can execute against displayed contra side interest in strict price/time; or price/size/time; or price/time that accounts for ECN access fees.

Upon entry, the OCF 25 will ascertain what market participant is the next Quoting Market Participant in queue to receive an order based on the entering MP's ordering choice, and depending on how that receiving Quoting Market Participant participates in system 20 (i.e., automatic execution v. order delivery), the OCF 25 will either cause delivery of an execution (via SOES^{SM}) or delivery of a Liability Order (via SelectNet®).

Also in some embodiments, the market 10 can have a class of orders referred to as preferenced orders. A preferenced order is an order that is preference to a particular quoting market participant e.g., market maker or ECN. Preferenced Orders can be of two types price restrictions or no price restrictions. Preferenced Orders of either type are entered into the system 20 through the Non-Directed Order Process. The market participant entering the Preferenced Order designates the quoting market participant by its identification symbol (“MPID”). Preferenced Orders are processed in the same “queue” as Non-Directed Orders and are sent from the queue when the preferenced quoting market participant quote satisfies the order.

For example, if MMA and ECN1 (non-automatic exception participant) are at the inside bid each displaying 1,000 shares at $20, and OE Firm A enters a market order to buy 1,000 shares, assuming that MMA is first in time priority, the OCF 25 will route the order into the SOES^{SM} and deliver an execution of 1,000 shares to MMA via the SOES^{SM}. If another market order to buy 1,000 shares is entered into the system, the OCF 25 will deliver a Liability Order to ECN1. If ECN1 had opted to take automatic execution, the OCF would have delivered an execution to ECN1 via the SOES^{SM}.

Order Execution Manager

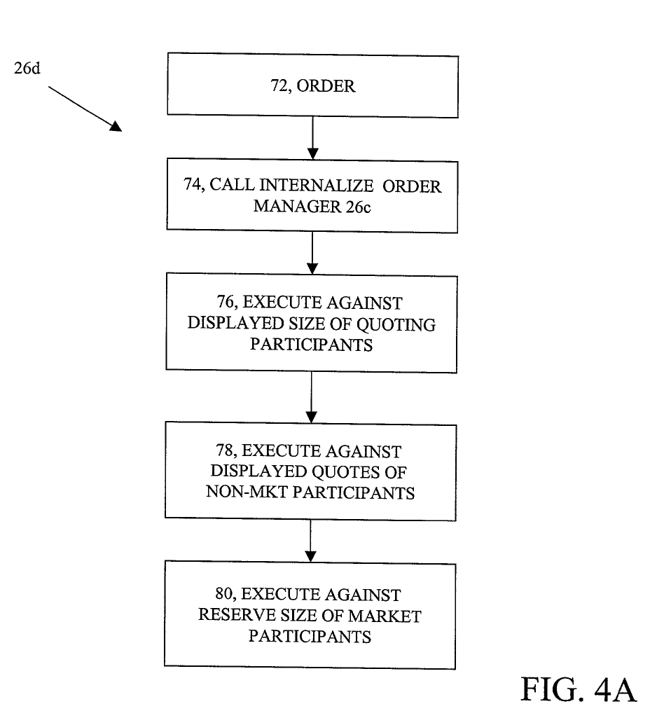

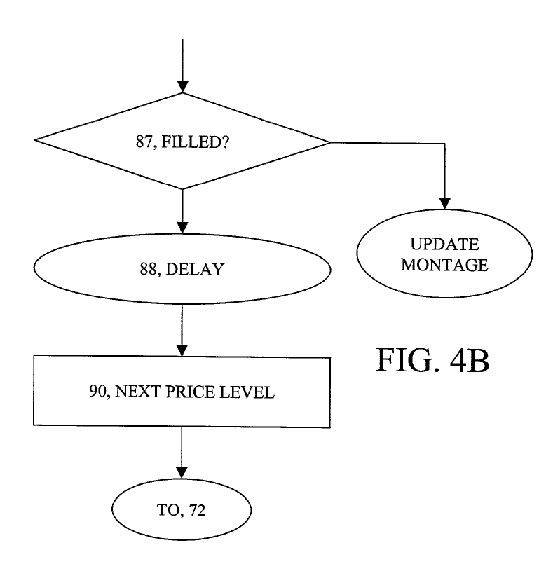

Referring to FIG. 4A, an exemplary order execution/routing manager 26d executes non-directed orders against Quoting Market Participant's quotes/orders based on, e.g, price/time priority. As noted above, other priorities can be used and the execution/routing manager 26d would be so modified. Each quote/order when entered into the OCF 25 receives a time stamp. The order execution/routing manager 26d will deliver all orders at the best bid/best offer generally in strict time priority based on the time stamp of the order/quote, subject to the order execution choice preferencing features, and self matching feature, with the exception that order execution/routing manager 26d will first attempt to provide a match off of orders/quotes entered by a Quoting Market Participant if the participant is at the best bid/best offer by calling 74 an internal execution manager 26c. Thus, the order execution/routing manager 26d will call the internal order execution manager 26c to try to match off a Quoting Market Participant's orders and quotes that are in the system if the participant is at the BBO and receives a market or marketable limit order on the other size of the market.

Generally, the order execution/routing manager 26d will attempt to execute 76 against all displayed size (attributable and non-attributable) at a particular price level for market participants such as market makers and ECN's. There does not need to be an interval delay between the delivery of executions against a market maker's quote (assuming the market maker has size to access) because all Quoting Market Participants may quote their actual size and may give multiple orders and price levels. As shown herein the market maker proprietary orders receive preference over agency orders. However, preference could be given to agency orders before market maker orders.

Once displayed size in system 20 is exhausted, the order execution/routing manager 26d will attempt to access the quotes of UTP Exchanges. After accessing the displayed size of Quoting Market Participants and UTP Exchanges 78, order execution/routing manager 26d will attempt to execute 80 against the reserve size of Quoting Market Participants generally in price/time priority, subject to the exceptions noted above.

In an alternate embodiment, the order execution/routing manager 26d can distinguish between exchanges that support auto execution and exchanges that do not support auto execution giving preference for the former. Additionally, in such an embodiment, UTP exchanges can have reserve size and the system 20 can distinguish between exchanges that support auto execution and those ECN's, and then exchanges that do not support auto execution.

In another embodiment the order execution/routing manager 26d can first access quotes of market makers and auto-execution ECN's, next access quotes of market makers and ECN's for delivery of orders, then the reserve size of market makers and ECN's and UTP exchanges. Other arrangements priorities, etc. are possible taking into consideration how participants participate in the market 10, choices of how orders interact in the market 10, the system or customer choices.

Referring to FIG. 4B, if the order is not filled 88, the order execution/routing manager 26d will move 90 to the next price level, immediately in one embodiment, or in another embodiment, after a predefined delay, e.g., a 5 second interval delay 87 before attempting to execute an order at the new price level. The price-level interval delay will give market participants time to adjust their quotes and trading interests before the market moves precipitously through multiple price levels, which may occur when there is news, rumors, or significant market events. Thus, the price-level interval delay is a modest and reasonable attempt to limit volatility.

For non-directed orders that are mixed orders or odd lot orders the collector facility process 25 (FIG. 2B) calls an odd-lot execution manager 26f.

Odd-Lot Processing

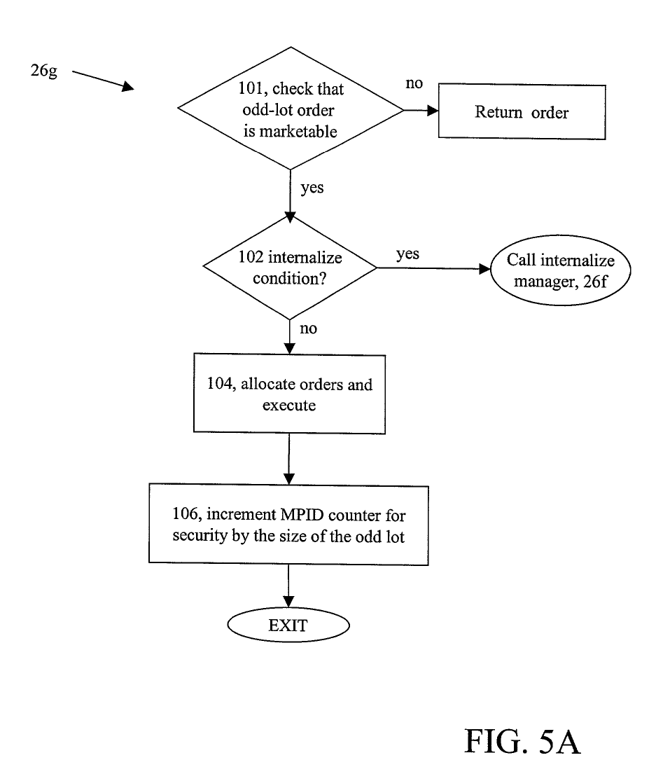

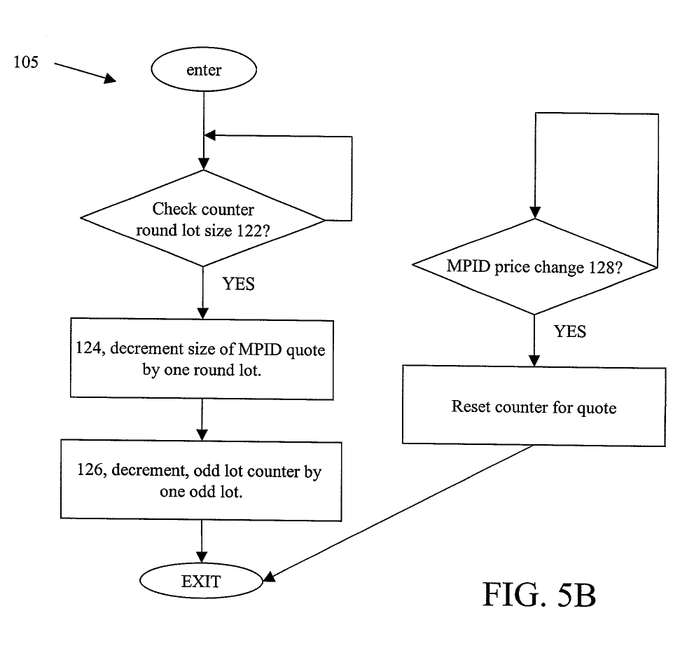

Referring to FIG. 5A, an odd lot execution manager 26g is shown. The odd lot execution manager 26g accepts and executes orders that are for less than one normal unit of trading, i.e., odd-lot orders or orders less than one round lot (e.g., 100 shares for equities). In some embodiments, the odd lot execution manager checks 101 if the odd lot order is marketable. If it is marketable it is further processed otherwise it is returned to the entry firm. Also in some embodiments, odd lot and mixed lot orders are handled as immediate or cancel (IOC) orders.

The odd lot execution manager 26g is a separate mechanism for processing and executing these orders as distinct from normal units of trading. Odd lot execution manager 26g determines 102 whether an internalize condition exists, where the odd lot and mixed lot orders entered by an eligible market participant, e.g., “MMA” matches the MPID of the incoming odd lot order, which indicates that the incoming order corresponds to an order from one of MMA's customers. The process will check that MMA is at the inside price. If MMA is at the inside price the orders will be directed to their displayed size at the inside price regardless of time priority similar matching off processing of round lot orders. Otherwise Odd lot and mixed lot orders are allocated 104 to Market Makers and exchanges with unlisted trading privileges (UTP's) when the market makers/exchanges at the inside price in the same manner as round lot processing. In some embodiments all Market Makers at the inside could be required to participate in odd lot executions.

The odd lot execution manager 26g establishes and maintains odd lot counters for each security. In one embodiment, the counters are software constructs or data structures that allow the market 10 to track long and short positions of each of the odd lot eligible participants. When an eligible market participant is allocated an odd lot or mixed lot order, the odd lot portions of the order are used to increment 106 the odd lot counters for that security for the particular eligible market participant by the size of the odd lot portions of the order(s). Initially the counters are established at zero for each participant that accepts or is required to accept odd lot orders.

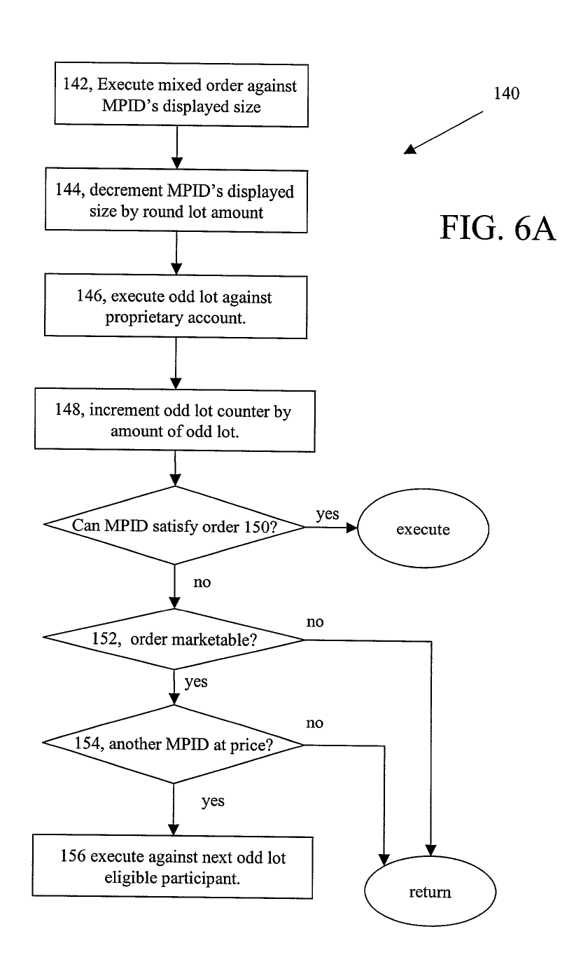

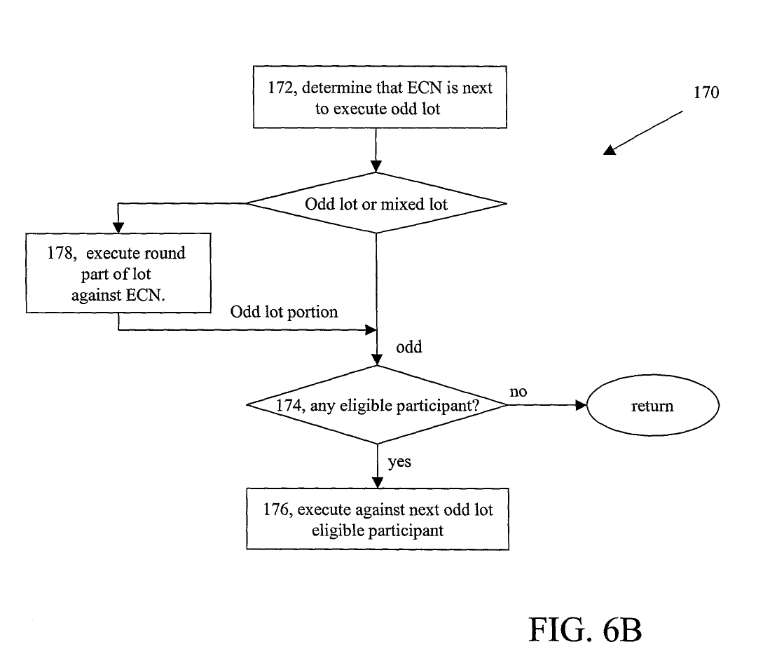

The MPID “SIZE” quote is modified in the odd lot process as explained in FIGS. 6A-6C below. Only round lot orders maybe placed in the order book or displayed “SIZE.” The odd lot execution manager 26g will decrement a market participant's, e.g., MMA's display size only in round lot quantities. The corresponding position of the eligible market participant, e.g., odd lot counters, e.g., MMA (buy or sell) is decremented. The MPID odd lot counters (buy and sell) are reset, i.e., zeroed out when there is a price change of the eligible market participant at the inside price, and at the end of the trading day, e.g., at 4:00 p.m. EST or other such time as established by the market 10 or other governing body.

With these features, internal delays (i.e., 5 second execution delay against same Market Maker at the same security; and maximum rate of one order per second per participant) do not exist.

Referring to FIG. 5B, a process 120 for decrementing odd lot eligible market participant (MPID) displayed size for odd lot execution is shown. Orders for odd lots are executed 104 against the eligible market participant. Positions are tracked on both sides of the market by accumulating the positions 106 in the corresponding eligible market participant's buy or sell odd lot counters, as described above in FIG. 5. The counter for the particular eligible market participant is checked 122. If the counter reaches one round lot or greater, the eligible market participant's displayed size is decremented 124 by one round lot and the counter is decreased 126 by 100 shares in the security, e.g., a round lot. The balance of the amount of the counter remains in the counter. If at any time, the eligible market participant's displayed price changes 128 (i.e., moves to a different price) the odd lot counter for the eligible market participant at that side of the market, e.g., buy or sell, is reset or zeroed out 130. Odd lot counters 132 are zeroed out at the end of each trading day; i.e., 4:00 p.m. EST.

Referring to FIG. 6A, the following process 140 can be used for decrementing odd lot eligible market participant displayed size for mixed lot orders executing against quotes reflecting round lot quotes/orders. Mixed lot orders are executed 106 against eligible market participant's displayed size. The system 10 executes 142 the mixed lot against the particular eligible market participant to its round lot displayed size plus the odd lot portion of the order. The displayed size is decremented 144 for the round lot portion executed. The odd lot portion of the order will execute 146 against the eligible market participant's proprietary account and increase 148 the appropriate (buy/sell) odd lot counter of the eligible market participant by the odd lot quantity.

The mixed lot process 140 checks 150 if the eligible market participant can satisfy the order. If the eligible market participant cannot satisfy the entire size of the mixed lot order, the remaining balance (round lots) of the order, if still marketable 152, will be executed 154 against the next eligible market participant at that price. If there is not another eligible market participant at the inside price (all size at the inside price is exhausted), and the remaining balance is still marketable, then the balance is given for execution 156 to the next odd lot eligible market participant at the new inside price. If the order is not marketable, or if there is not another eligible market participant the process 140 will cause the system 10 to return 158 the remaining balance to the entry firm.

Referring to FIG. 6B, the following process 170 can be used for odd lot and mixed lot executions against non-odd lot eligible ECN's that are at the inside price. The process 170 will detect that an odd lot order was entered and determine 172 that an ECN is next in line at the inside to receive the order. If there is not another odd lot eligible market participant at the inside price, then the system 10 will return 176 the order to the entry firm. Otherwise, the order will be executed 176 against the next odd lot eligible market participant at the inside price.

If a mixed lot market order is entered, and an ECN is next in line at the inside to receive the order, the process 170 delivers the round lot portion to the ECN 178 and gives 180 the remaining balance of the mixed lot order, to the next eligible market participant at the inside price. If there is no eligible market participant at the inside and the ECN is still at the inside, the process 170 will cause the system 10 to return 176 the remaining balance of the order to the entry firm. If there are eligible market participant left at the inside price, the system 10 will give the remaining balance to the first eligible market participant at the new inside price.

A similar process can be used with limit orders. If a mixed lot limit order is entered, and an ECN is next in line at the inside price to receive the order, the system 10 delivers the round lot portion of the order to the ECN and gives the remaining balance, if still marketable, to the next eligible market participant at the inside price. If there no eligible market participant remains at the inside price, or the remaining balance is no longer marketable, the system 10 returns the remaining balance of the order to the entry firm.

In an ECN partials a round lot, that is the ECN fulfills part but not all of the lot, the remaining portion of the order that is sent back to the system 10 will be designated an immediate or cancel (IOC) order. The remaining portion will be executed if an eligible market participant is at the inside or if not, the remaining balance will be sent back to the order entry firm.

For example, a market participant “MMA” enters a market order to buy 50 shares of a security into the system 10. When the odd-lot order becomes marketable, i.e., when the best price in the system moves to the price of the odd-lot limit order, odd lot execution manager 26g will immediately and automatically call the odd lot process 100 to execute the order. Executions can be at the inside price against the market maker that is next in rotation. Market maker MMA's offer counter for the security is incremented by the 50 share amount. Thereafter, if another odd-lot order is received, by market maker MMA, e.g., for 95 shares of the same security, the odd lot process 100 will again execute the order and increment the market maker's offer counter for the security by the 95 share amount.

The odd lot execution manager 26g decrements MMA's displayed size for odd lot execution. The counter will be decremented by 100 shares leaving a 45 share balance in the counter and the MMA's displayed quote and the “SIZE” quote if used the system will be each decremented by 1 round lot.

The minimizes the potential for suspension of odd-lot processing in the security. This processing assures swift and robust processing of odd-lot transactions. Additionally, the use of the odd-lot process can result in such robust processing in other markets besides those that use market makers.

Other embodiments are within the scope of the following claims.

What is claimed is:

1. A method for trading odd-lots of a security in an electronic market for trading securities, comprises
executing an odd-lot order with an eligble market participant; and
updating an odd-lot position of the eligible market participant to reflect the executed odd-lot order;
determining when the odd-lot position for the eligible market participant corresponds to a round lot size; and
decrementing the odd-lot position by the round lot size.

2. The method of claim 1 further comprising:
determining whether the received odd lot order is from a customer of the eligible market participant who is at an inside price; and
executing the received odd lot order against the eligible market participant irrespective of a time priority of the eligible market participant.

3. The method of claim 1 further comprising
determining if the odd-lot order is a marketable order.

4. The method of claim 1 wherein the electronic market maintains the displayable quote size for the eligible market maker for the security traded in the market.

5. The method of claim 4 wherein the displayable quote size for the market maker in the security is decremented by one round lot when decrementing position of the eligible market participant.

6. The method of claim 1 wherein if the odd lot order is not marketable when received from an order entry firm it is returned to the order entry firm.

7. The method of claim 1 wherein the odd-lot positions are track for both sides of the market and are specified for the security traded by an eligible market participant and for each eligible market participant.

8. The method of claim 1 wherein the odd-lot execution manager is a separate mechanism for processing and executing orders distinct from normal units of trading.

9. The method of claim 1 wherein the odd lot order is part of a mixed lot.

10. The method of claim 1 wherein a round lot portion of the mixed lot is executed against the eligible market participant's displayed quote.

11. The method of claim 1, further comprising:
resetting the odd-lot position for the eligible market participant if the eligible market participant changes its corresponding displayed quote.

12. The method of claim 1, further comprising:
resetting the odd-lot position for the eligible market participant at the close of trading on the market.

13. An electronic market for trading securities, comprises:
an order execution/routing manager that executes non-directed orders against quoting market participant's quotes/orders based on a priority;
a process to determine whether an order is a mixed order or an odd lot order;
an odd-lot execution process that executes the odd-lot portion of the mixed order or the odd-lot order, comprising:
a process to execute an odd-lot order with an eligble market participant;
a process to update an odd-lot position of the eligible market participant to reflect the executed odd-lot order and determine when the odd-lot position for the eligible market participant corresponds to a round lot size; and
a process to decrement the odd-lot position by the round lot size.

14. The electronic market of claim 13 further comprising:
a process to determine if the odd-lot order is a marketable order.

15. The electronic market of claim 13 further comprising
a process to determine whether the received odd lot order is from a customer of the eligible market participant who is at an inside price; and
a process to execute the received odd lot order against the eligible market participant irrespective of a time priority of the eligible market participant.

16. The electronic market of claim 13 further comprising:
a process to reset the odd-lot position for the eligible market participant at the close of trading on the market.

17. The electronic market of claim 13 wherein the odd lot order is part of a mixed lot.

18. The electronic market of claim 13, wherein a round lot portion of the mixed lot is executed against the eligible market participant's displayed quote.

19. The electronic market of claim 13 wherein
a process to suspend processing of odd-lot orders for the security if the process to determine whether an odd-lot exposure has been exceeds determines that all exposure limits for all market makers have been exceeded.

20. A computer program product residing on a computer readable medium for trading securities in an electronic market, comprises instructions for causing a computer to:
determine whether a received order is a mixed order or an odd lot order;
execute an odd-lot order with an eligble market participant;
update an odd-lot position of the eligible market participant to reflect the executed odd-lot order and determine when the odd-lot position for the eligible market participant corresponds to a round lot size; and
decrement the odd-lot position by the round lot size.

21. The computer program product of claim 20 further comprising instructions to cause the computer to:
determine whether the received odd lot order is from a customer of the eligible market participant who is at an inside price; and
execute the received odd lot order against the eligible market participant irrespective of a time priority of the eligible market participant.

22. The computer program product of claim 20 further comprising instructions to cause the computer to:
determining if the odd-lot order is a marketable order.
